(19) United States
(12) Patent Application Publication
(10) Pub. No.: US 2023/0231465 A1
(43) Pub. Date: Jul. 20, 2023

(54) Advanced Power Control Techniques

(71) Applicants: Hengchun Mao, Allen, TX (US); Yuxin Li, Stillwater, OK (US)

(72) Inventors: Hengchun Mao, Allen, TX (US); Yuxin Li, Stillwater, OK (US)

(21) Appl. No.: 18/099,227

(22) Filed: Jan. 19, 2023

Related U.S. Application Data
(60) Provisional application No. 63/301,155, filed on Jan. 20, 2022.

(51) Int. Cl. H02M 1/00; H02M 7/219; H02M 3/07; H02J 50/12; H02M 1/08

(52) U.S. Cl. CPC H02M 1/0058; H02M 7/2195; H02M 3/07; H02J 50/12; H02M 1/083; H02M 1/0025; H02J 2207/20

(57) ABSTRACT

A device includes a switch network having a plurality of power switches and coupled to a dc rail with a dc voltage, and a resonant tank coupled to the switch network. The resonant tank has a first coil and a resonant capacitor. Gate drive signals of a group of power switches of the plurality of power switches in the switch network are configured to be turned on with a phase shift against a zero crossing of a current in the resonant tank, and the phase shift is configured to adjust the dc voltage or establish a soft-switching condition for the plurality of power switches in an operation mode.

### CROSS REFERENCE TO RELATED APPLICATIONS

This application claims priority to U.S. Provisional Application No. 63/301,155, filed on Jan. 20, 2022, entitled “Advanced Wireless Power Transfer Techniques”, which is herein incorporated by reference.

### TECHNICAL FIELD

The present invention relates to power conversion and power electronics devices and systems, and, in particular embodiments, to advanced power control techniques for wireless power transfer systems and devices and other applications.

### BACKGROUND

Wireless power transfer (WPT) is desirable for many applications due to better customer experience and better tolerance of harsh environment. Although the basic theory of WPT has been known for many years, and WPT technologies have been used in some applications in recent years, it has been a challenge to achieve high efficiency wireless power transfer for a wide range of applications with different power levels at low cost. Also, the EMI and noise from a WPT system can cause interference to other electronic devices nearby, and may present hazards to people and other animals in the close environment, which are significant concerns when the power of the WPT system is high.

Therefore, improvements are needed to design and control a wireless charging system with good performance. The goals include developing WPT systems through good power control with high efficiency, low magnetic emission, and low cost.

### SUMMARY OF THE INVENTION

These and other problems are generally solved or circumvented, and technical advantages are generally achieved, by preferred embodiments of the present invention which provides an improved WPT system and other power processing devices based on advanced power control.

According to one embodiment of this disclosure, a device has a plurality of power switches and is coupled between a dc rail with a dc voltage and a resonant tank. The resonant tank has a first coil and a resonant capacitor. Gate drive signals of a group of power switches of the plurality of power switches in the switch network are configured to be turned on with a phase shift against a zero crossing of a current in the resonant tank, and the phase shift is configured to adjust the dc voltage or establish a soft-switching condition for the plurality of power switches in an operation mode.

According to another embodiment of this disclosure, a system includes a first device and a second device. The first device comprises a first switch network having a plurality of first power switches, which is coupled between a first dc rail with a first dc voltage and a first resonant tank having a first coil and a first resonant capacitor. Gate drive signals of a group of the first power switches in the plurality of first power switches in the first switch network are configured to be turned on with a phase shift against a zero crossing of a current of the first resonant tank. The phase shift is configured to adjust the first dc voltage or to establish a soft-switching condition for the plurality of first power switches in an operation mode. The second device comprises a second switch network with a plurality of second power switches and coupled between a second dc rail with a second dc voltage and a second resonant tank having a second coil and a second resonant capacitor, and the second coil is magnetically coupled to the first coil.

According to yet another embodiment of this disclosure, a method comprises configuring a switch network having a plurality of power switches and coupled between a dc rail with a dc voltage and a resonant tank with a coil and a resonant capacitor, and detecting a zero crossing of a current flowing in the resonant tank. The method also includes configuring gate drive signals of a group of power switches of the plurality of power switches to be turned on with a controllable phase shift against the zero crossing, and adjusting the phase shift to adjust the dc voltage or to establish a soft-switching condition for the plurality of power switches in an operation mode.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of a wireless power transfer system with a full-bridge switch network and two detuning branches in accordance with various embodiments of the present disclosure;

FIG. 2 illustrates a control block diagram and gate drive signals of the detuning switches shown in FIG. 1 in accordance with various embodiments of the present disclosure;

FIG. 3 illustrates a hysteresis control block diagram and gate drive signals of the detuning switches and power switches shown in FIG. 1 in accordance with various embodiments of the present disclosure;

FIG. 4 illustrates a block diagram of a wireless power transfer system with a half-bridge switch network and a detuning branch in accordance with various embodiments of the present disclosure;

FIG. 5 illustrates a PWM control block diagram and gate drive signals of the detuning switches and power switches shown in FIG. 1 in accordance with various embodiments of the present disclosure;

FIG. 6 illustrates a block diagram of a WPT system with a soft gate drive in accordance with various embodiments of the present disclosure;

FIG. 7 illustrates several block diagrams of a WPT system with various soft gate drive schemes in accordance with various embodiments of the present disclosure;

FIG. 8 illustrates an exemplary gate drive diagram of switches in a WPT device in accordance with various embodiments of the present disclosure;

FIG. 9 illustrates another exemplary gate drive diagram of switches and dc rail voltage in a WPT device in accordance with various embodiments of the present disclosure;

FIG. 10 illustrates an exemplary block diagram of a battery charging system with a WPT device in accordance with various embodiments of the present disclosure;

FIG. 11 illustrates another exemplary block diagram of a battery charging system with a WPT device in accordance with various embodiments of the present disclosure;

FIG. 12 illustrates exemplary key operational waveforms of a WPT device in a battery charging system in accordance with various embodiments of the present disclosure;

FIG. 13 illustrates an architecture of a WPT device with a linear battery charger in accordance with various embodiments of the present disclosure;

FIG. 14 illustrates another architecture of a WPT device with a linear battery charger in accordance with various embodiments of the present disclosure;

FIG. 15 illustrates another architecture of a WPT device with a voltage blocking switch and a linear battery charger in accordance with various embodiments of the present disclosure;

FIG. 16 illustrates a block diagram of a WPT device with switchable half-bridge cells in accordance with various embodiments of the present disclosure;

FIG. 17 illustrates another block diagram of a WPT device with switchable half-bridge cells in accordance with various embodiments of the present disclosure;

FIG. 18 illustrates a block diagram of a WPT system with various control blocks in accordance with various embodiments of the present disclosure;

FIG. 19 illustrates a set of typic gate drive schemes with phase-shift control schemes in accordance with various embodiments of the present disclosure; and

FIG. 20 illustrates another set of typic gate drive schemes with phase-shift control schemes in accordance with various embodiments of the present disclosure;

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely in WPT devices and systems. The invention may also be applied, however, to a variety of other device or systems, including integrated circuits, power converters, power supplies, signal processing circuit or devices, any combinations thereof and/or the like. Hereinafter, various embodiments will be explained in detail with reference to the accompanying drawings.

Power efficiency, electromagnetic emission, system reliability and system cost have been critical factors impacting the design and adoption of WPT technologies. This is especially true when fast charging is required, where higher power is required. This disclosure presents innovative techniques that can provide significant improvement in these aspects, especially aiming at maintaining a good efficiency and smooth power control over a wide range of power and voltage. Although the invention will be discussed in a context of wireless charging or WPT applications, it can be also applied to other signal transmission or power conversion applications, in which some of the coils may be combined into a transformer if desired.

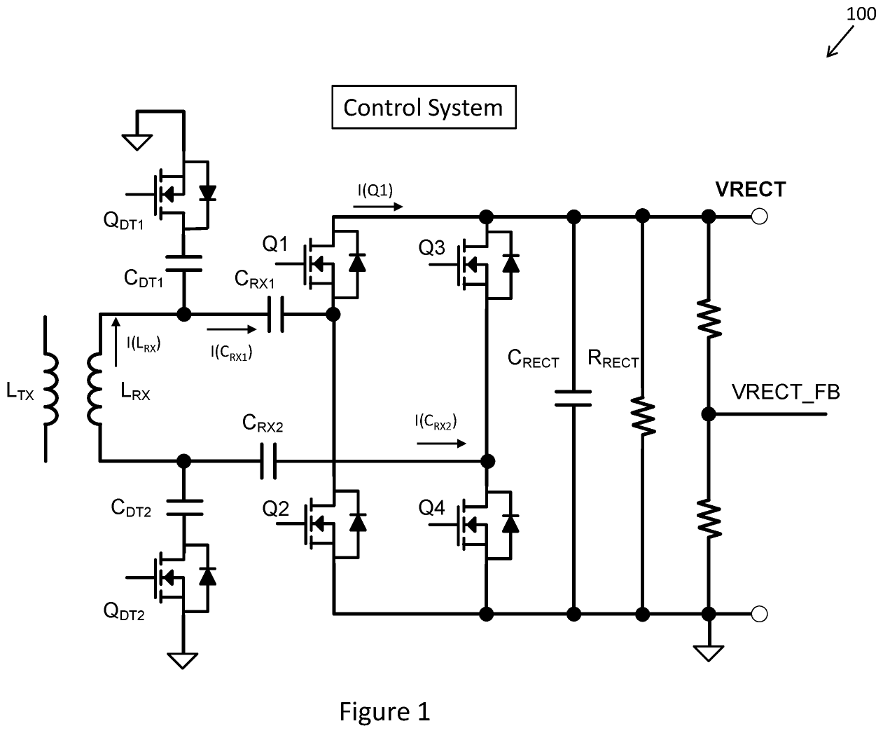

A wireless power transfer system consists of a plurality of transmitters (TX) and a plurality of receivers (RX), and a transmitter and a receiver may have a plurality of coils. We will use an example system of a transmitter with a TX coil and a receiver with a RX coil to explain the innovative features of this disclosure, but the underlying technology can be applied to devices and systems with more TX and RX and more coils. FIG. 1 shows a simplified block diagram of such a system, with the TX symbolized by the TX coil L_{TX}, and the remaining components form an RX. Usually, a transmitter inverter generates an Alternative Current (AC) voltage and/or current and applies it to the transmitter coil L_{TX}, so generally the impact of the TX on the RX can be represented by the current in L_{TX}, the current in L_{TX} is controlled by the system to provide a proper output from the RX. When a receiver coil L_{RX} is magnetically coupled with the TX coil, an AC voltage and/or current is generated in the RX coil. In the RX, 4 power switches Q1-Q4, shown as MOSFETs here but may be implemented as other components such as diodes or IGBTs, form a full-bridge synchronous rectifiers (SR) (generally called a switch network), and are connected between a dc rail VRECT whose voltage is also referred as VRECT and a RX resonant tank consisting of the RX coil L_{RX} and resonant capacitors C_{RX1} and C_{RX2}. As shown in FIG. 1, the switch network (Q1-Q4) rectifies the AC voltage in the RX coil into a Direct Current (DC) voltage VRECT, or vice versa converts a dc voltage VRECT to an ac voltage applied to the RX resonant tank to process power flowing in the other direction in a bidirectional RX. Other type of rectifiers and resonant tanks may be used to perform this function if desired. During normal operation, VRECT, or current from this rail, needs to be controlled to a suitable value with all variations occurred in a WPT system, and in an abnormal operation, the VRECT need to be limited within a safe range to protect the RX and its load.

Since the SR rectifier can still deliver energy to its output (VRECT rail in this case) even if all MOSFETs are turned off due to the MOSFETs' body diodes, detuning the RX resonant tank has been traditionally used to protect the RX and its load from over-current or over-voltage faults during abnormal. In FIG. 1, Q_{DT1} and Q_{DT2} are detuning switches. C_{DT1} and C_{DT2} are detuning capacitors, and the capacitance value of C_{DT1} and C_{DT2} are much higher (for example at least 2-3 times higher) than capacitance of the resonant capacitors C_{RX1} and C_{RX2}. When both Q_{DT1+} and Q_{DT2} are turned on, the receiver coil(s) is effectively bypassed by C_{DT1} and C_{DT2}, such that the energy in the receiver coil is not transferred to VRECT, so over voltage or over current at the output can be avoided.

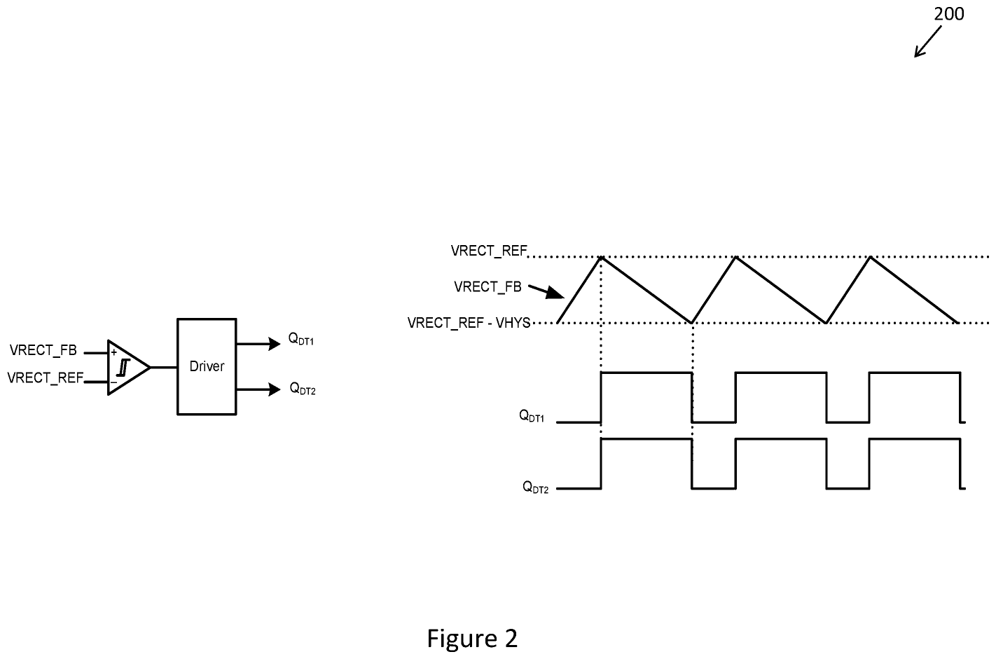

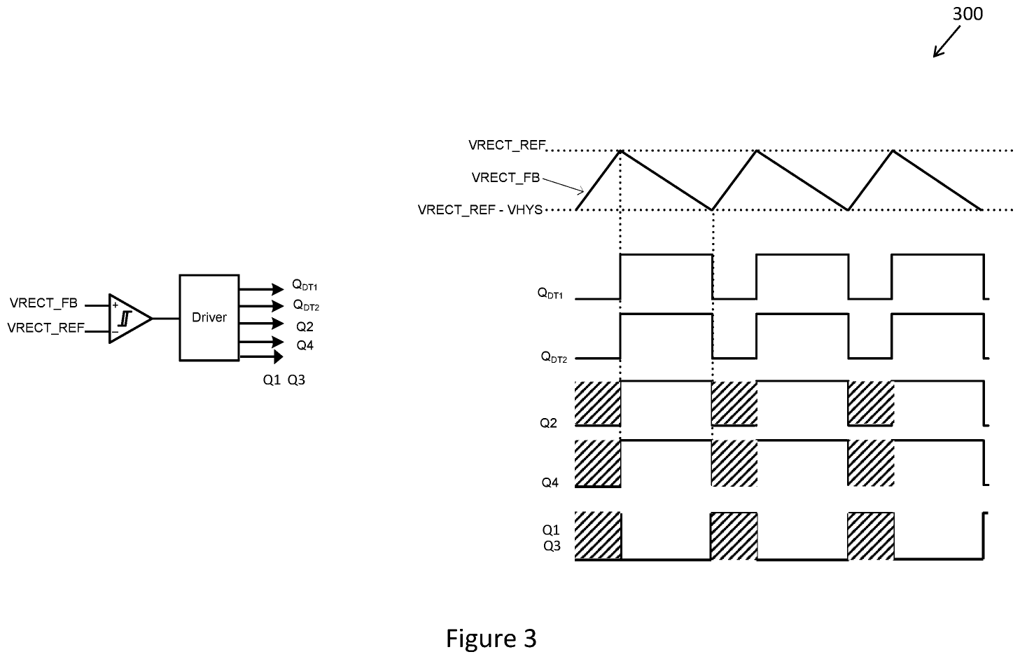

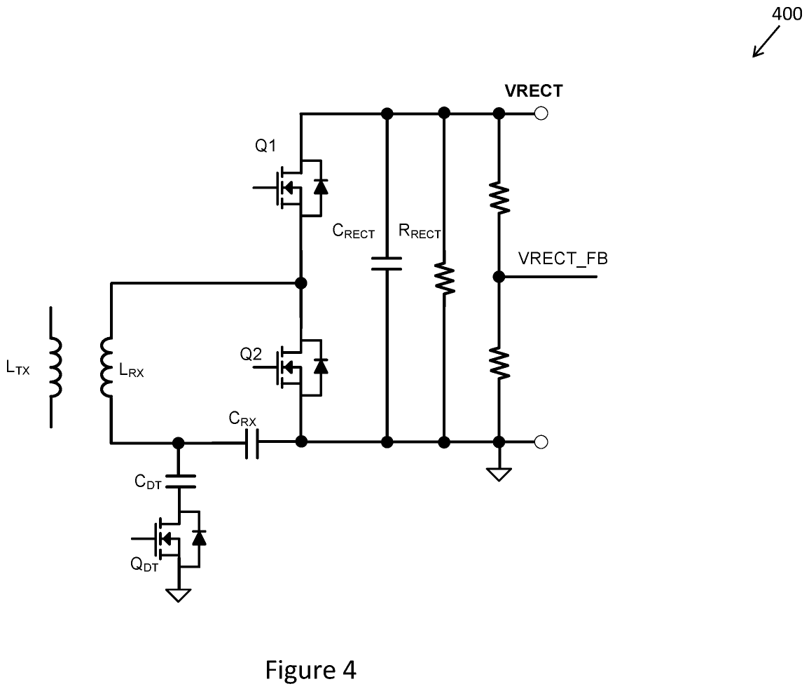

It is also possible to use detuning for power control. The detuning switches can be controlled with various control methods, such as using a hysteric comparator, which is shown in FIG. 2 as an example. In FIG. 2 the sensed feedback signal of VRECT, VRECT_FB, is compared with a reference voltage VRECT_REF. Once VRECT_FB is greater than VRECT_REF, the detuning switches are turned on, which leads to interruption of energy transfer to the output, and the output voltage VRECT decreases. Once VRECT drops below another threshold (VRECT_REF−VHYS, where VHYS is the hysteresis), both Q_{DT1} and Q_{DT2} can be turned off and the energy in L_{RX} is transferred to the output VRECT and VRECR rises. With such hysteresis control, the VRECT voltage is regulated within the hysteresis window defined VRECT_REF and VRECT_REF−VHYS, as shown in FIG. 2. The gate drive signals, labeled the same as the switch numbering, are shown in the right side of FIG. 2. Power switches Q2 and Q4 can be turned on in synchronization with Q_{DT1} and Q_{DT2}, with a typical timing diagram shown in FIG. 3. In shaded area, Q_{DT1} and Q_{DT2} are turned off with their gate drive signals remain low, and Q1-Q4 can be gate on and off according to rectification or power control strategy. The duration corresponding to the shaded area may last many cycles of the current in L_{RX} (a cycle of the L_{RX} current is usually determined by the switch frequency of the inverter in the TX). When Q_{DT1} and Q_{DT2} are turned on, Q2 and Q4 are also turned on with Q1 and Q3 turned off, so no power and energy are transferred between VRECT and L_{RX}. This scheme of using detuning as a power control mechanism can be applied to other rectifier or resonant tank topologies. FIG. 4 shows a half-bridge rectifier example with just one detuning branch in which Q_{DT} is a detuning switch and C_{DT}a detuning capacitor. This circuit, configured similarly as in FIG. 1 except for a half bridge instead of a full bridge topology being shown for the switch network, functions similarly to the circuit shown in FIG. 1. The detuning switch and power switches in the half bridge can be controlled in a similar fashion to the ones shown in FIGS. 2 and 3.

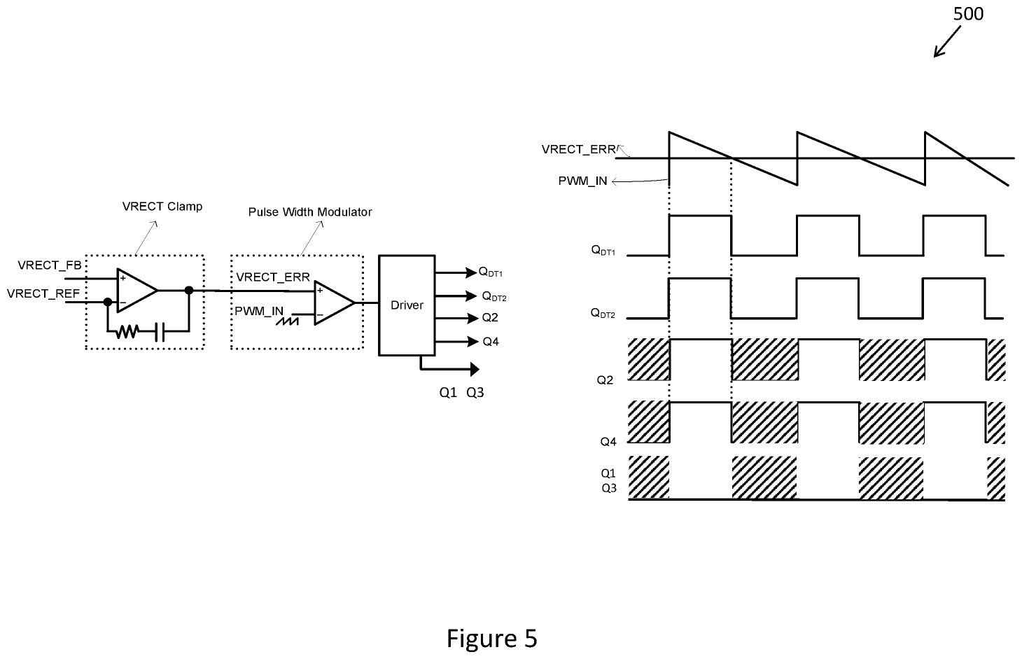

Instead of hysteresis control, Pulse Width Modulation (PWM) control may also be used to control the detuning to regulate the output power (voltage or current) of an RX. For the configuration with a full-bridge SR shown in FIG. 1, VRECT can be controlled with a PWM control scheme as shown in FIG. 5 to implement voltage clamp or control, for a protection or regulation purpose. The VRECT clamp block is an error amplifier, which compares VRECT feedback voltage VRECT_FB voltage with VREC_REF and generates an error signal VRECT_ERR with compensation functions exemplified by the resistor and capacitor in the block. Pulse Width Modulator modulates the error signal against a PWM ramp signal PWM_In, and generates gate drive signals for detuning switches Q_{DT1} and Q_{DT2}, and preferably also for power switches Q1 through Q4. With the closed-loop control shown in FIGS. 2, 3 and 5, the SR's output voltage VRECT can be regulated and clamped. A typical timing example is also shown at the right side in FIG. 5. The gate drive signals of the switches are labeled the same as the switch numbering, following the same convention as in previous figures. In the time duration for the shaded area (which may last many cycles of the current in L_{RX}), Q_{DT1} and Q_{DT2} are turned off, Q1-Q4 can be gate on and off according to rectification or power control strategy to transfer power between VRECT and the RX coil L_{RX} as a first operation mode. When the detuning switches are turned on, no power nor energy is transferred between VRECT and L_{RX} as a second operation mode, in which Q2 and Q4 can be gated on while Q1 and Q3 be gated off to save gate drive loss. By controlling the duty ration of the second operation mode over the first operation mode, the power delivered to or from VRECT is controlled in a PWM manner.

The RX rectifier (and its transmitter counterpart TX inverter) may use different topologies, such as full-bridge, half-bridge, class-E etc. As is known in the industry, different topologies have different characteristics, and can be used to accommodate different operating scenarios. Because a WPT system can operate over a very wide range of conditions, for example with a wide range of magnetic coupling strength, voltage and current at the input and/or output, especially if a transmitter or receiver needs to cope with a variety of devices. It is possible to switch between different topologies during operation. We will use a topology switching in a RX with two common SR topologies full-bridge and half-bridge as an example. The full-bridge SR shown in FIG. 1 consists of switches Q1, Q2, Q3 and Q4. If switches Q4 or Q2 is constantly on, and MOSFET Q3 (or Q1) is constantly off, the full bridge SR can be configured to work in a half bridge mode.

A full-bridge SR and a half-bridge SR have their own characteristics. Under the same TX coil and RX coil magnetic coupling and load conditions, after converting a full-bridge SR to a half-bridge SR, VRECT increases (nearly doubled) and SR's gate drive loss is reduced to half at the expense of increased conduction loss. Dynamically reconfiguring full-bridge or half-bridge operation modes can optimize efficiency and power transfer capability without interrupting power conversion. Selection of operation topology is based on loading conditions and TX to RX magnetic coupling condition, and can change dynamically to adapt to an operation condition change. However, dynamically changing the topology in operation is a big disturbance and may cause SR's current and voltage to surge or overshoot. This kind of electrical surge or overshoot may reduce the system's reliability. Smooth transition from operation in one topology to operation in the other topology is desired.

When the SR operates in a full-bridge topology, the resonant tank sees an AC voltage reflected from the DC voltage VRECT, with both the positive peak and the negative peak equal to VRECT. When the SR is switched into a half-bridge topology, the reflected AC voltage from VRECT is halved, so its positive peak and negative peak both equal to VRECT/2, and its rms value is reduced to half also, which can cause a fast current surge in the resonant tank, resulting in oscillation and spikes in the system. There are similar disturbances during transition from half-bridge to full bridge transition. Therefore, during a topology transition it is important to manage both the resonant tank current and reflected ac voltage to avoid voltage/current overshoot or oscillation.

Since the main reason for the disturbances is the difference of reflected ac voltage seen by the RX resonant tank, it is possible to smoothen the transition by implementing a gradual change of this voltage. As the rectifier is usually implemented with synchronous rectifiers such as MOSFETs, a full-bridge rectifier may be controlled with a phase shift between the gate timing of the two switch legs in the full-bridge topology. When the phase shift is zero, the rectifier operates in normal rectification mode emulating a diode bridge. However, as the phase shift increases, the reflected voltage reduces. Ideally, if the reflected voltage changes gradually between the full voltage and 50% voltage, the topology transition between full bridge and half bridge can be smoothened. Alternatively, the duty of switches in the leg to be disabled in the half-bridge mode can be controlled as if in an asymmetrical half bridge and changed gradually. For example, if the half-bridge mode is implemented as Q3 OFF, and Q4 ON strategy, then during a topology switching transition, Q1 and Q2 can be controlled normally, but the duty cycle of Q3 and Q4 can have a gradual change. During a full-bridge to half-bridge transition, the duty cycle of Q4 can be changed from an initial state (in which Q4 is approximately in synchronization with Q2 with roughly equal duty cycle but 1800 phase difference), gradually increasing to 100%, while the duty cycle of Q3 decreases to 0 gradually during this process in a fashion complementary to Q2. The transition is reversed in a half-bridge to full-bridge transition. Please note that during such transitions the clock signals for Q3 and Q4 are always in synch with Q1 and Q2, so the power delivered to the output also sees gradually change, and system performance is relatively smooth. If needed, the TX can be controlled in coordination with the RX topology-switching transition (or vice versa) to achieve desired operation of the system. Please note also that the phase-shift control, i.e. adjusting the relative timing of switches in a leg against switches in the other leg in the same full-bridge topology, may be used to regulate the output of the RX during steady-state operation, which can allow the reflected voltage to be optimized according to system operation parameters such as magnetic coupling variation with given limitation on input and output conditions, such as voltage, current, and power ranges. Preferably, the phase-shift control should be arranged such that when the RX coil current is around the positive and negative peaks, the rectifier pass the rectified coil current to the output, so that a high RX efficiency can be maintained. Also, the current waveform delivered to the output should be approximately symmetric to the peak, so the harmonic emission is relatively low. Details of such phase-shift control will be explained later.

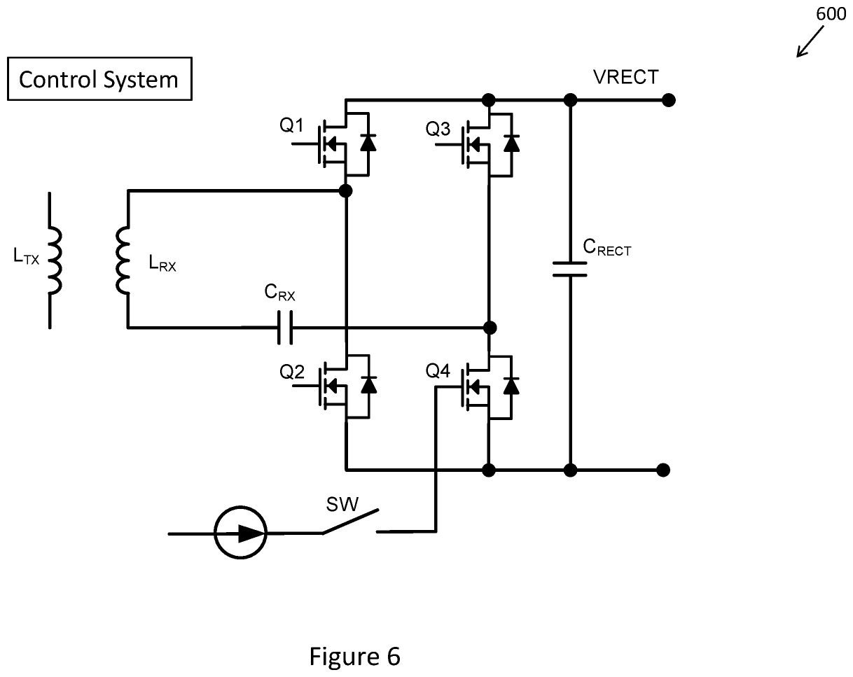

Often, a power switch is implemented as semiconductor switches such as power MOSFETs or IGBTs in various technologies. The conduction of the power switch is thus controlled by its gate voltages. For example, the resistance of a MOSFET switch is dictated by its gate voltage. To alleviate or avoid big surges during a transition in the RX or TX, it is also possible to slow down the turn-on of corresponding MOSFET switches to increase its effective resistance during the transition, to provide a limiting factor for current increases in the main power circuit. A slow gate driver with a controlled charging current can be implemented as shown in FIG. 6 to facilitate such surge limiting. After the gate switch SW is turned on, the current source charges the gate of MOSFET Q4, Q4's gate voltage VGS goes up slowly. When the gate voltage VGS reaches MOSFET's threshold voltage, Q4 starts turn-on, but due to the small pull up current, the turn-on of Q4 takes a relatively long time. During the slow turn-on process, the resonant current and VRECT overshoot may be avoided. Of course, such slow gate drivers may also be used for other power switches.

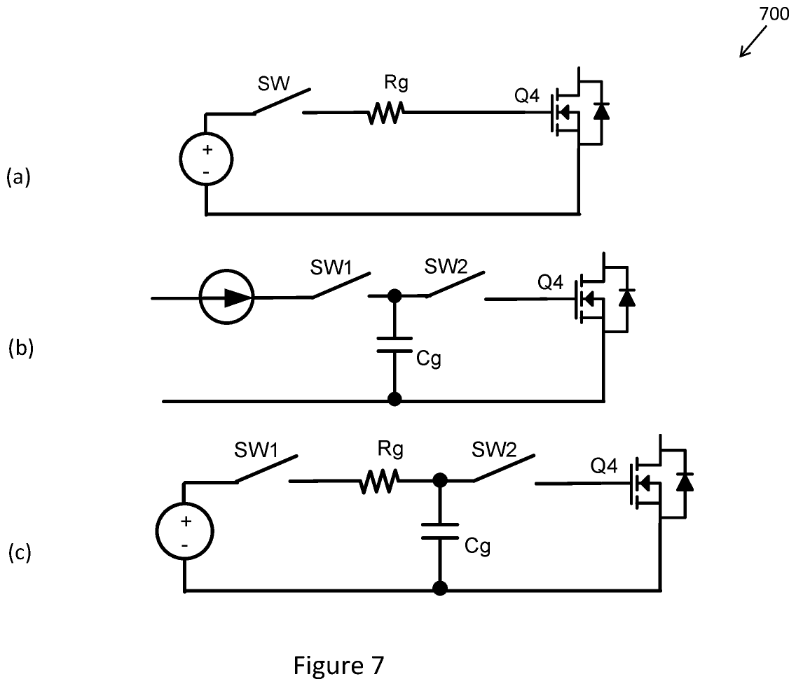

Slow gate drivers can be implemented with different circuits, and a few examples are shown in FIG. 7. The basic principle remains the same: after a gate switch SW turns on, a circuit with limited current slowly charges Q4's gate so that Q4 turns on slowly until it is saturated. In FIG. 7(a), a gate resistor Rg is connected to the gate of Q4, with the parasitic capacitance Cgs from gate to source, the drive signal is delayed. Also, Rg limits the current flowing into the gate of Q4, therefore Q4 can also be slowly turned on. In FIG. 7(b), additional capacitance Cg is added to further slow down the gate voltage rising. In FIG. 7(c), Rg and Cg are used to reduce the rising of gate voltage. The circuit variations in FIGS. 7(a), 7(b) and 7(c) are examples to show that simple circuits with resistors, capacitors and switches can be used to shape the gate drive voltage of semiconductor switches, and thus slow down the turn on of power switches.

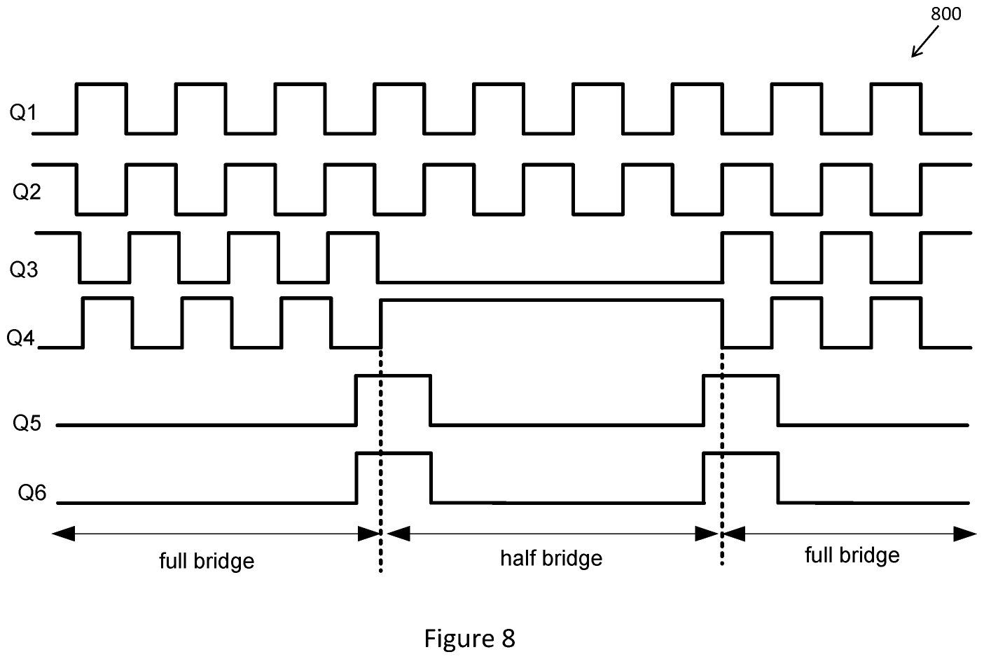

For the full-bridge SR with detuning circuit shown in FIG. 1, when detuning switches Q5 (Q_{DT1}) and Q6 (Q_{DT2}) are turned on, the resonant tank is bypassed by C_{DT1} and C_{DT2}, and the power switches Q1 through Q4 have low current during this detuned operation. The topology switching operation may be performed with the help of detuning to reduce the current in power switches. FIG. 8 shows typical drive signals with topology-switching between the full-bridge mode and half-bridge mode. The duration of each mode, including the transition time during which Q5 and Q6 are turned on, is not drawn to scale, and should last long enough for the intended operation (and is usually many cycles of L_{RX} current). Please note that the drive signals of the detuning switches may be aligned with the power switches to reduce their surge current or voltage during topology-switching transitions. Due to the existence of resonance in the circuit, the switches may be operated under soft-switching conditions. For example, a detuning switch may be gated on when the voltage across its drain and source is low, and turned off when the current is conducting through its body diode.

Before or during a transition, the TX coil current on transmitter side be adjusted lower through communication between the transmitter and the receiver. Or during a detuning operation, the TX may sense an abrupt change of its coil current or other signals (such as inverter switch current, or resonant capacitor voltage or impedance matching circuit current/voltage), and as a result reduce the TX coil current, further reducing the voltage and current stress during a big transition such as a topology switching.

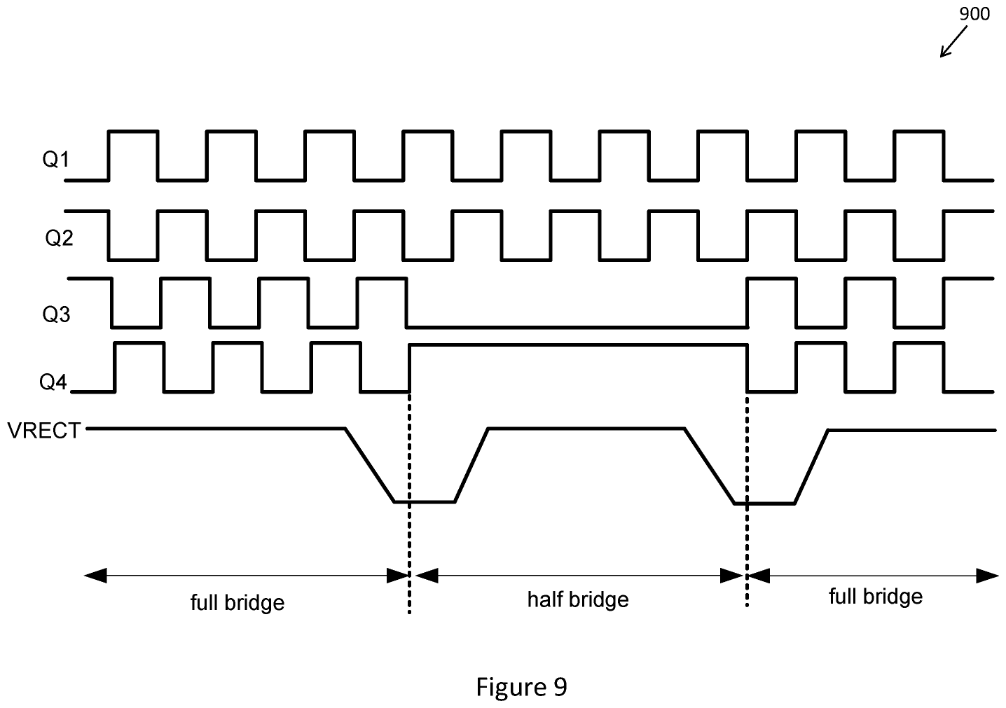

Equivalently, VRECT may be reduced around the topology change transition to limit the voltage and current stress. Before a topology switching, the reference voltage VRECT_REF can ramp down to reduce the voltages and currents in the TX and RX, so the operation topology can be switched at lower SR output voltage and lower transmitter coil current. After the transition is complete, the reference voltage can ramp up to a desired value. Such a transition process is shown in FIG. 9. By doing this, the voltage and current surge or overshoot can be reduced, while voltage regulation for VRECT can be also maintained in RX circuit. This may be accomplished with or without a detuning operation or a detuning circuit.

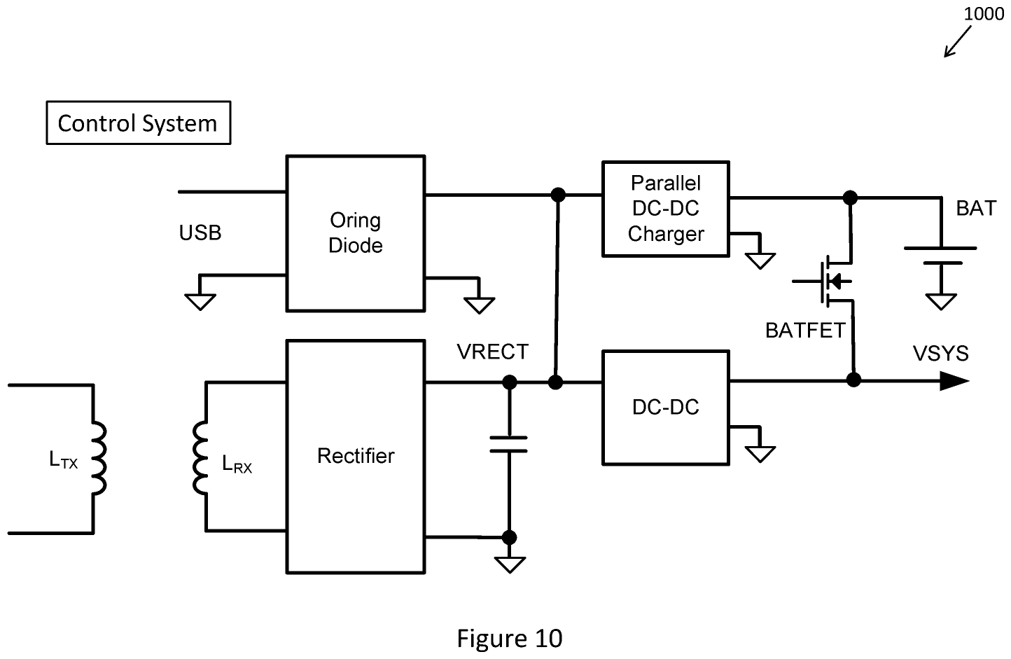

Usually, a wireless charger is used in combination with a wired charging system. The charger control can be coordinated with the RX control to facilitate topology switching and other functions to reduce the voltage and current stress during such transitions. To improve system efficiency in high power battery charging, the architecture shown in FIG. 10 can be utilized. A wired power input USB is connected in parallel with the output VRECT of a RX (symbolized by a RX coil L_{RX} and a rectifier) through an Oring circuit labeled as Oring Diode. A bidirectional switch BATFET (which may be implemented as two back-to-back MOSFETs) is used to isolate battery BAT from system voltage VSYS when necessary, so that VSYS can be powered up properly and independently even when the battery is completely dead or at low voltage. The BATFET is also called a power path control. The DC-DC Converter and the Parallel DC-DC Charger can be implemented as switching power converters, linear power regulators, switched-capacitor ratio converters and any combination thereof. The DC-DC converter and BATFET combined can be called a DC-DC switching charger with power path control. If power path control is not needed, BATFET may be eliminated and the battery BAT can be connected to VSYS. Diode Oring may be implemented with switches such as MOSFETs to reduce its power loss.

To improve charging efficiency, a switched-capacitor converter with a fixed or variable ratio is usually preferred as a DC-DC converter or parallel charger. In such an application, VRECT needs to be regulated to a voltage which is the battery voltage times the voltage ratio of the switched-capacitor converter. When the USB input is used as the power input for the charger, VRECT may be adjusted by adjusting the output voltage of the USB adaptor (not shown in the figure) which supplies power to the USB input. When the wireless input is selected as the power input, VRECT could be adjusted by the TX symbolized by L_{TX} through a communication channel between the TX and the RX, or within the RX. In this architecture, the DC-DC converter and/or the parallel charger is responsible for battery short protection, battery pre-charge and battery top-off (constant voltage charge) as well as charge termination. To achieve high efficiency, the DC-DC converter and/or the parallel charger may have a bypass mode operation in which power is passed through without switching power switches.

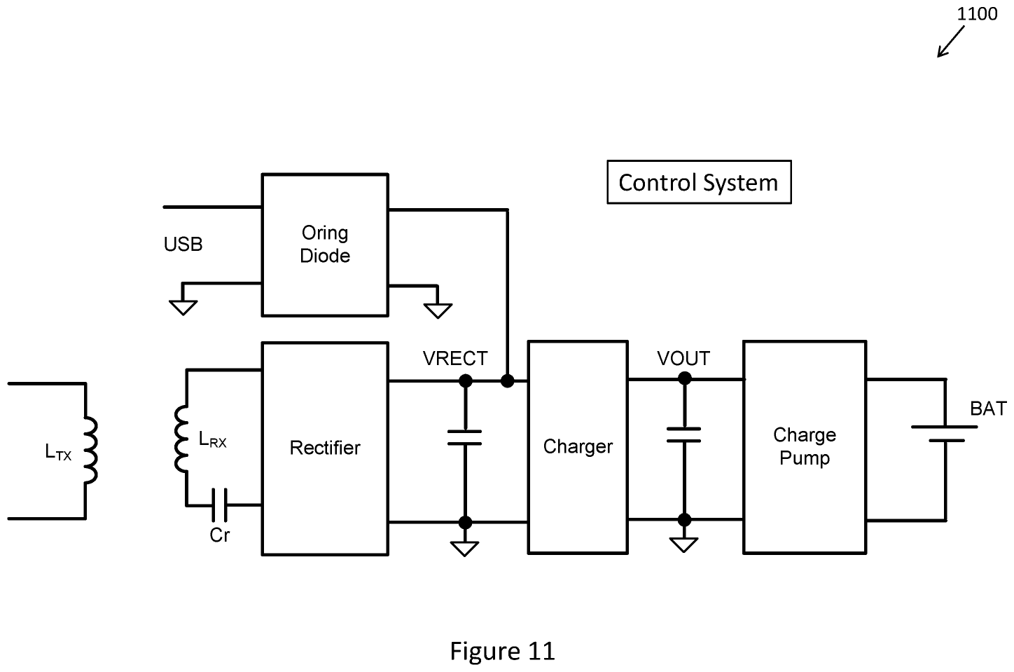

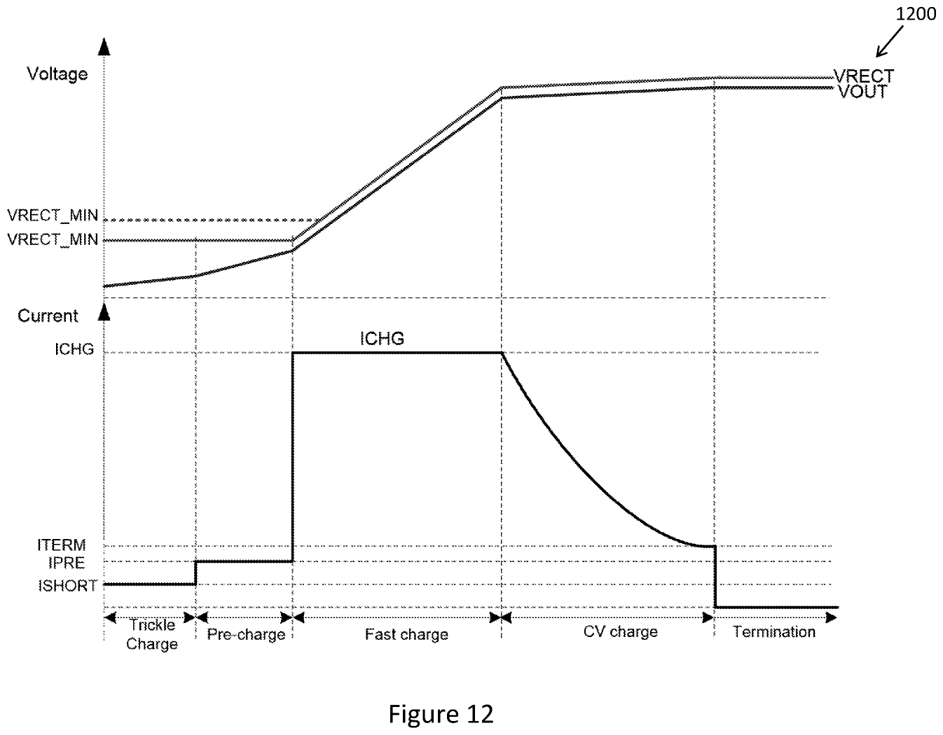

A novel architecture is shown in FIG. 11, where a charger is connected in series with a charge pump and the charge pump (labeled as Charge Pump) is connected to a battery BAT. The charge pump is a switched-capacitor converter with a fixed or variable ratio. The charge pump is optional, and the charger can be directly connected to BAT (battery) if desired. VOUT or VRECT may be used as a system output. In this architecture, the charger may provide full battery charging control functions, including pre-charge, Constant Current (CC) charge, Constant Voltage (CV) charge, termination and recharge. Some of the battery charging control functions, such as pre-charge, termination or recharge, may be provided by the charge pump converter. Besides, the charger and/or the charge pump may also provide battery short protection, and switches in the charger or charge pump can be turned off to isolate the battery BAT when needed. As the charge pump and/or the charger may work with bidirectional power flow, the battery can provide energy to the system output in a battery-only mode. In this way, full or partial power path control function may be integrated into the charger or the charge pump. The charger may be implemented as a switching charger or linear charger. Vout may be regulated to closely follow the battery voltage (multiplied with the proper voltage ratio of the charge pump when needed), to allow the charger operating in minimum voltage drop from VRECT to VOUT in both CC charge and CV charge when the charging current is significant. In pre-charge and battery short mode, VRECT is regulated at minimum voltage VRECT_MIN. FIG. 12 illustrates the whole charge cycle: trickle charge (battery short), pre-charge, fast charge (CC charge), CV charge and termination. VRECT is regulated at VRECT_MIN when the battery reflected voltage VOUT is below VRECT_MIN. When VOUT voltage rises close to VRECT_MIN, then VRECT voltage starts tracking VOUT with a suitable voltage drop such that charge efficiency is optimized. VRECT is controlled to track battery voltage in CC and CV charge as well as in charge termination.

For the wireless input, VRECT can be regulated by the transmitter or the receiver. Voltage regulation methods in a transmitter or receiver include but are not limited to:
Adjusting input voltage to the transmitter
Pulse width modulation (PWM) of transmitter power switches
Frequency modulation of transmitter power switches
Resonance modulation in transmitter and/or receiver when a resonant capacitor is implemented as a variable capacitor
Receiver skip-mode operation or detuning
Receiver phase-shift control

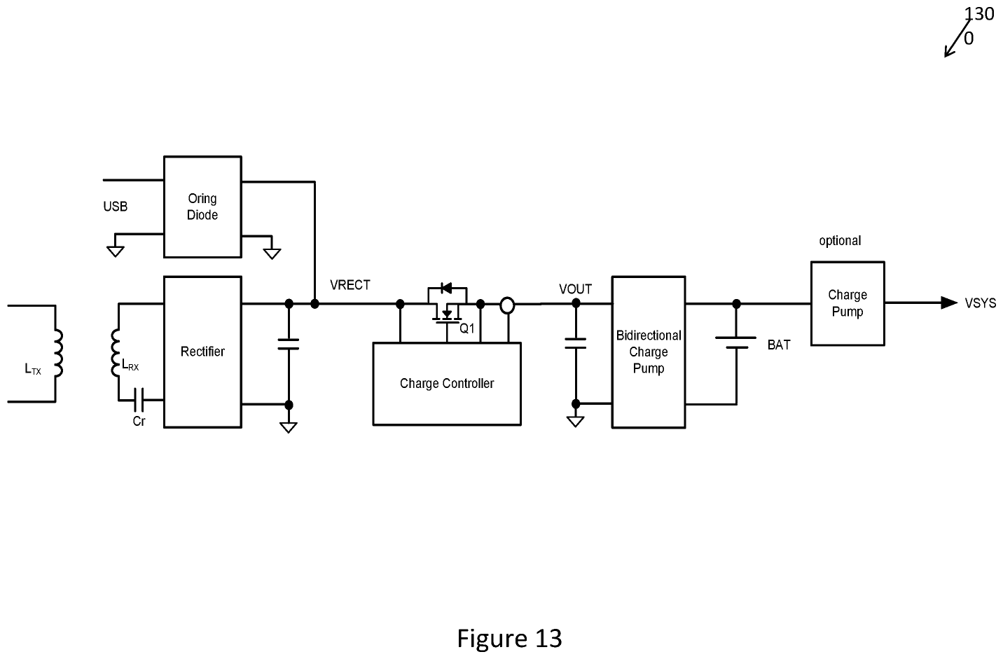

Also, the charger may be implemented as a linear mode operation of the switches in the RX rectifier or the charge pump. FIG. 13 shows an example to implement the architecture to use a dedicated charger. The charge controller controls MOSFET switch Q1's gate voltage for the entire charge cycle. When the charging current is low such as in battery's trickle charging and pre-charge stages, Q1 may operate in linear mode. When the charging current is high such as in CC charging, Q1 may be fully on or in low dropout mode. When charging needs to be terminated, Q1 can be turned off. The voltage ratio of the optional charge pump may change based on a desired system voltage VSYS and the battery voltage VBAT, or other system parameters such as TX-RX magnetic coupling, charging current and system power. Again, the charge pump is optional and system can be connected to the battery, VRECT, or VOUT if needed.

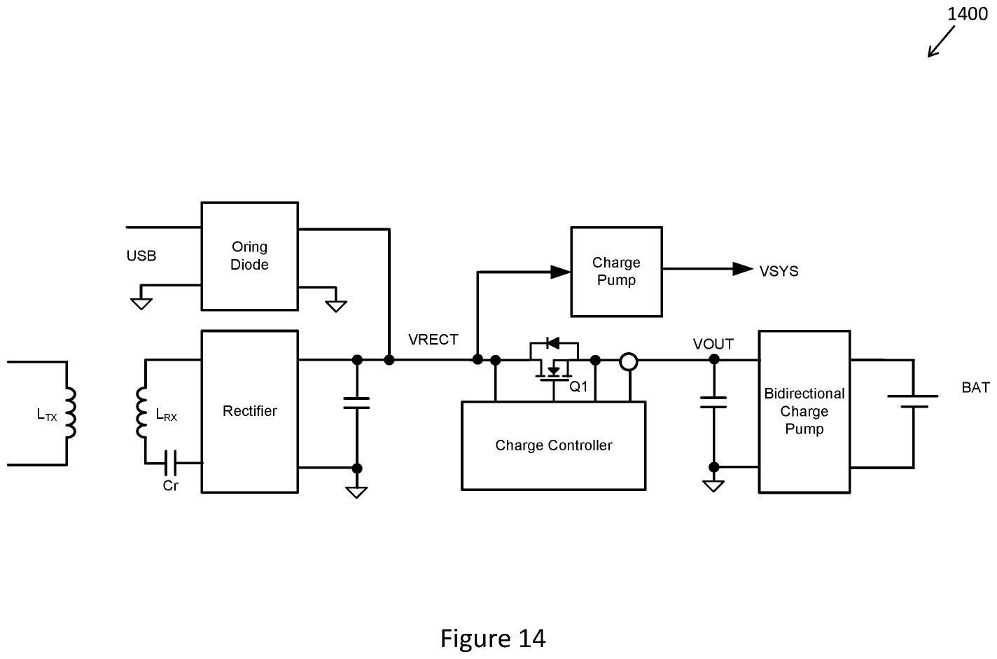

Power path control can be added as is shown in FIG. 14. When the battery is dead, at low voltage or floating, the system can be powered up from the USB input or the wireless input. The charge pump from VRECT to VSYS is optional and VSYS can be connected directly to VRECT (or VOUT) if desired. During battery only mode, battery supplies system through the bidirectional charge pump, MOSFET Q1 and optional charge pump to VSYS.

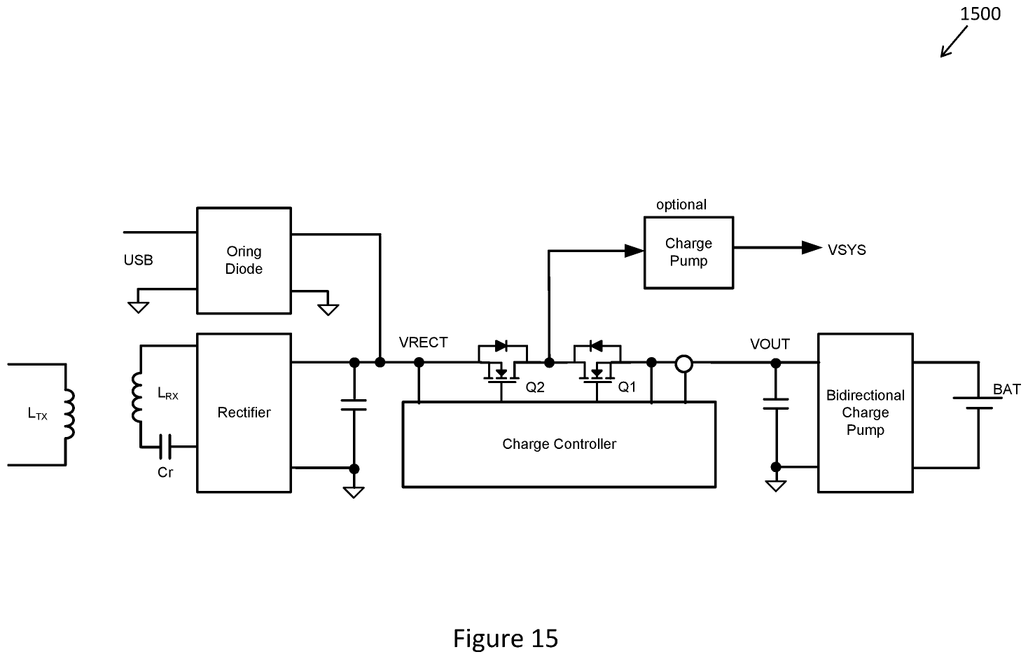

FIG. 15 shows an alternative implementation of battery charger with battery voltage tracking and power path. It is similar to, and functions similarly to, FIG. 14, but MOSFET Q2 is added to prevent the voltage from the battery BAT from being reflected to VRECT when desired.

Resonance modulation can be used in a RX to regulate its output voltage/current or adjust the operation of the wireless power system. With the position variations between TX and RX coils, the magnetic coupling between TX and RX coils, as well as the inductance of the coils, may vary in a wide range. Resonance modulation, usually implemented as changing a resonant capacitance of the RX resonance tank, can help regulate the output to a desired value, and/or maintain the system in a desired operation state. For example, when the magnetic coupling between the RX and TX coils is very strong, or the RX coil is exposed to a very strong magnetic field, the resonant capacitance of the RX resonator (resonant tank) can be intentionally moved away from its resonant point, at which the resonant frequency of the RX resonant tank is the same as the system frequency (at which the TX inverter is switched), by either limiting the maximum value of the capacitance or the lowest value of the capacitance, or by adding or removing a capacitor with sufficient capacitance to/from the resonant capacitor so that the resonant frequency is for sure significantly away from the resonant point. Through feedback control, this can increase the transmitter coil current and in turn the input voltage to the transmitter inverter if an impedance matching circuit is used, and thus reduce the current in the inverter circuit, reducing power losses in the inverter and impedance matching circuit. Such control is necessary when the magnetic coupling range of the system is very wide.

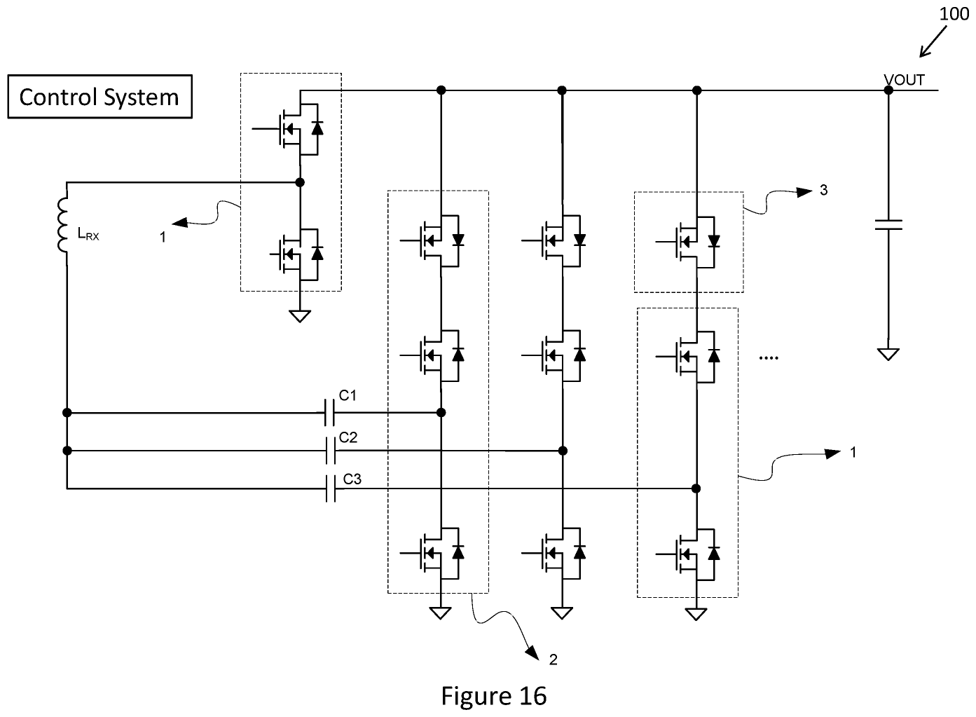

FIG. 16 illustrates a way to implement resonance modulation. The RX resonant tank consists of RX coil L_{RX} and a resonant capacitor network consisting of cell resonant capacitors C1 to C3 coupled to a switch network configured into a plurality of cells. The switches may be implemented as MOSFETs, and the switch network has specially configured cells including:
Block 1—a regular half bridge, which is optional (when this circuit is not present, the rectifier is in half-bridge configuration);
Block 2—a switchable half bridge cell, which includes a load switch (block 3) connected to a regular half bridge cell;
Block 3—a load switch to enable/disable a regular half bridge cell

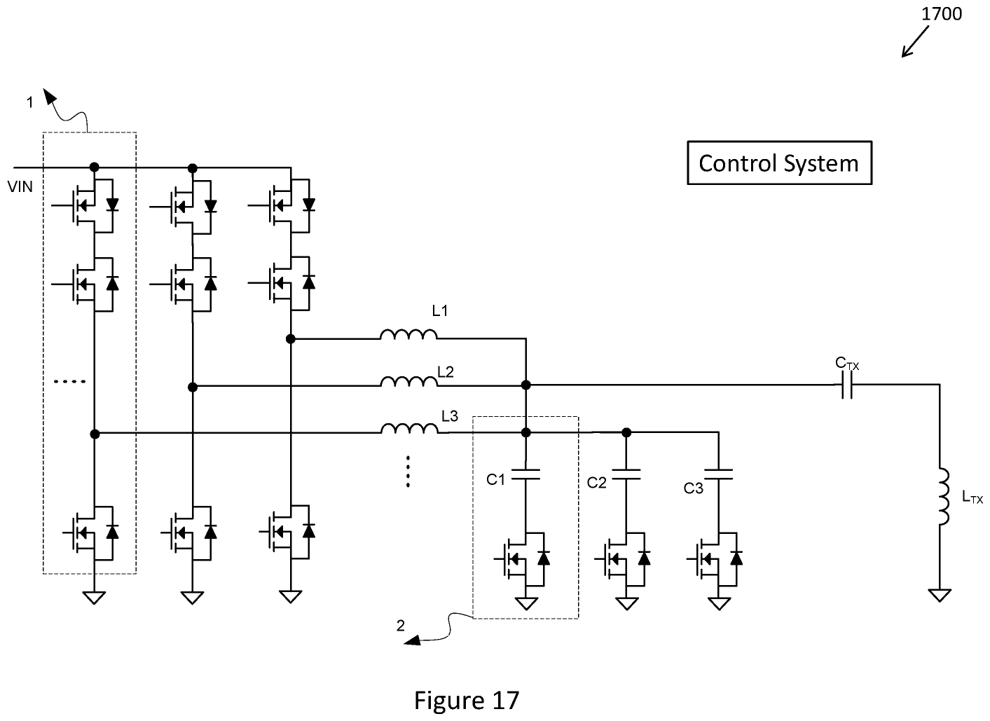

In this way, the power processing function of a half-bridge switch configuration is integrated with the adjustment of resonant capacitance. A half bridge thus may be divided into a plurality of regular and switchable half-bridge cells, each with a capacitor (or inductor if desired) coupled to its switching node (or ac node) as part of a resonant tank. When the load switch associated with a switchable cell is turned off, the associated capacitor (or inductor) is in effect removed from the resonant tank. The gate drives to the switches in the cell should be kept off during this time to save power loss. In this way, the resonant capacitance can be varied by switching the load switches, which determines the combination of cell resonant capacitors C1, C2, C3 to be switched into the resonant tank to function as an equivalent resonant capacitor. If all the half bridge cells are enabled, all the cell resonant capacitors C1, C2 and C3 are connected in parallel. The number of cells, the values of the capacitors and the size and ratings of the switches in each cell can be chosen to fit the application it is intended. In operation, a cell can be enabled or disabled (removed) when necessary. For example, when the magnetic coupling is very high, or the system is in a protection mode, it may be desired to move the RX resonant tank significantly away from its resonant point (for example, making the capacitance less than ⅓ of the resonant point value, or higher than 2 times the resonant point value). Then one or more cells can be added (enabled) or removed (disabled) to create a proper equivalent resonant capacitance for this operation mode. Please note that resonant capacitors may be also added to the other side of L_{RX}, or number of cells may be changed as needed. This concept can also be used to switch inductors or inductor-capacitor combinations. Shown in FIG. 17 is an example to illustrate an implementation in a transmitter. The TX resonant tank includes C_{TX} and L_{TX} coil. L1-L3 and C1-C3 form an impedance matching circuit which is another resonant tank, in which
Block 1—Switchable half bridge cell
Block 2—Switchable capacitor cell

With the switchable half bridge cells, any inductor combination of L1, L2 and L3 can be switched into or out from the LC network. Similarly, any combination of capacitors C1, C2, C3 can be switched into or out the LC resonant tank. Please note that usually a RX and/or TX can handle bidirectional power flow, so an TX can operate as a RX, and RX can operate as a TX if desired. Although the above discussion mainly uses RX as examples, the techniques can generally be applied to TX also. In TX mode, resonance modulation is usually used to create optimum soft switching conditions for power switches, but in RX mode, resonance modulation is mostly used to regulate the output. Although generally TX inverters work with a 50% duty cycle with symmetrical control, other control method can also be used. For example, a full-bridge TX inverter may use a phase-shift control or PWM control, and a half-bridge TX inverter may use asymmetric (complementary) PWM control in certain operation modes. Such control allows the current, voltage and power in the system be reduced quickly during an abnormal operation for fast protection or regulation, such as clamping the voltage or current of a component (e.g. power switch, coil, capacitor etc).

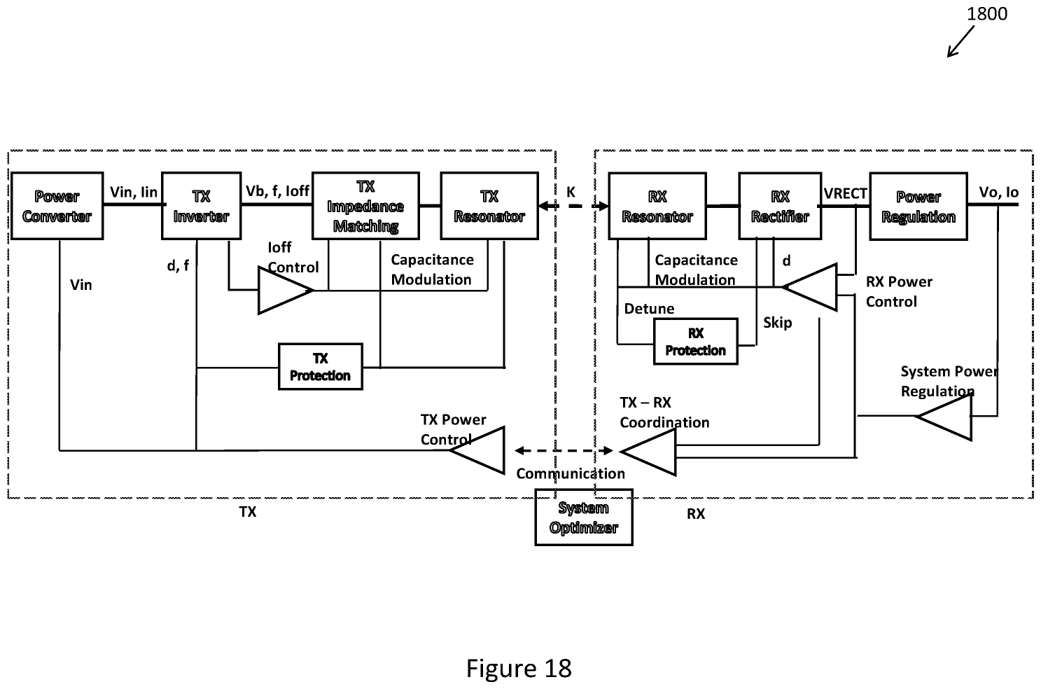

FIG. 18 shows an exemplary block diagram of a wireless power transfer system with a TX and a RX magnetically coupled together with a coupling coefficient of K, incorporating some of the techniques discussed above. The system power regulation block may control the system to provide desired output voltage Vo or output current Jo to the load at the output. A TX-RX coordination block may coordinate the references for key RX and TX operation voltages and currents according to the output of the system power regulation, so that the system may work smoothly and efficiently. The RX power control may use a reference signal from the TX-RX coordination block to regulate the RX output VRECT, through means such as RX rectifier duty control (including phase shift control, topology switching, skip-mode or hiccup/burst mode control), resonator resonance modulation such as resonant capacitance modulation, or detuning operation. The RX protection block monitors the current and voltage signals in the RX, and through detuning RX resonator and turning off power switches protects the components and load of the RX. Since the RX power control and protection are implemented locally, these functions can be performed with high bandwidth and within short time delay. At the same time, the TX can provide power and control functions related to RX in a lower bandwidth or with longer time delay. Such TX side control can be performed through an in-band or out-band communication channel, with one or more reference or control signals taken from the TX-RX coordination block. The TX power regulation may be performed through phase shift, duty cycle or frequency control of the TX inverter, or resonance modulation such as capacitance modulation in the TX resonator and/or the impedance matching circuit. Also, the input voltage to the TX inverter may be adjusted through a power converter in the input path or a power adapter coupled to the input of the TX. A TX protection block can monitor the components in the TX circuit for overvoltage or overcurrent conditions, and through adjusting the frequency and/or duty cycle of the TX inverter, or related component values in the impedance matching circuit and/or TX resonator, limits or clamps the voltage/current stress of the corresponding component. The control and protection within the TX can be performed fast, but if it is performed across the TX-RX boundary, it needs to have lower bandwidth and slower response to maintain a good stability, as it has to rely on usually slow communication between the TX and the RX. A system optimizer can monitor various signals in TX circuit and RX circuit, and determine the most suitable reference values in the system and the best topologies in RX and TX circuits. For example, if the magnetic coupling between the TX coil and RX coil is very weak (i.e. K is small), the WPT system may not be able to provide full power at the output. Then some references in the RX power regulation and system regulation may be adjusted lower to avoid over stresses in TX and RX components. The RX rectifier may work in a half bridge mode, and/or a voltage ratio of the power regulation circuit coupled to the RX may be adjusted lower if possible. If the magnetic coupling is very strong, cares should be taken to avoid the input voltage of Vin to be driven to too low in high power operation, as the resulting current in the power inverter may be too high for the power switches and the impedance circuit. If such case, the duty cycle of the TX inverter may be intentionally reduced, and/or the inductance or the capacitance of the impedance matching circuit may be adjusted in the TX side, or the resonant capacitor may be moved away from resonance point, and/or the duty cycle of the rectifier be reduced (such as increasing the phase shift) in the RX side, so the input voltage to the TX inverter is maintained at a reasonable level. Generally, in steady-state operation the RX resonator should be configured to operate near the resonant point, but during this extremely high coupling operation, the capacitance of the RX resonant capacitor can be intentionally limited at a suitable value. This can be performed automatically through the TX-RX coordination block and RX power control with the system optimization block monitoring the input voltage and switch current of the TX inverter or other related signals. The system optimization block can be located in the TX or in the RX, or its functions can be divided between the TX and the RX.

Because a control loop across the TX and RX boundary involves communication between the RX and the TX, the control speed is generally very slow. To achieve desired power regulation performance at the RX output, especially during fast transits, a fast power (voltage or current, or both) control loop local to the RX is desired. In such a case, the slower power control loop involving the TX can be used mainly to help obtain good steady-state performance such as low power loss and/or good efficiency across a wide operating range, while the faster RX power control loop may be used to achieve good voltage regulation during transients, such as load change, coupling change or other disturbance, in a similar way as discussed above for topology changing transients. When the rectifier has active switches as synchronous rectifier, phase shift control in the rectifier, briefly presented in previous discussion, is an effective method to regulate the power output quickly.

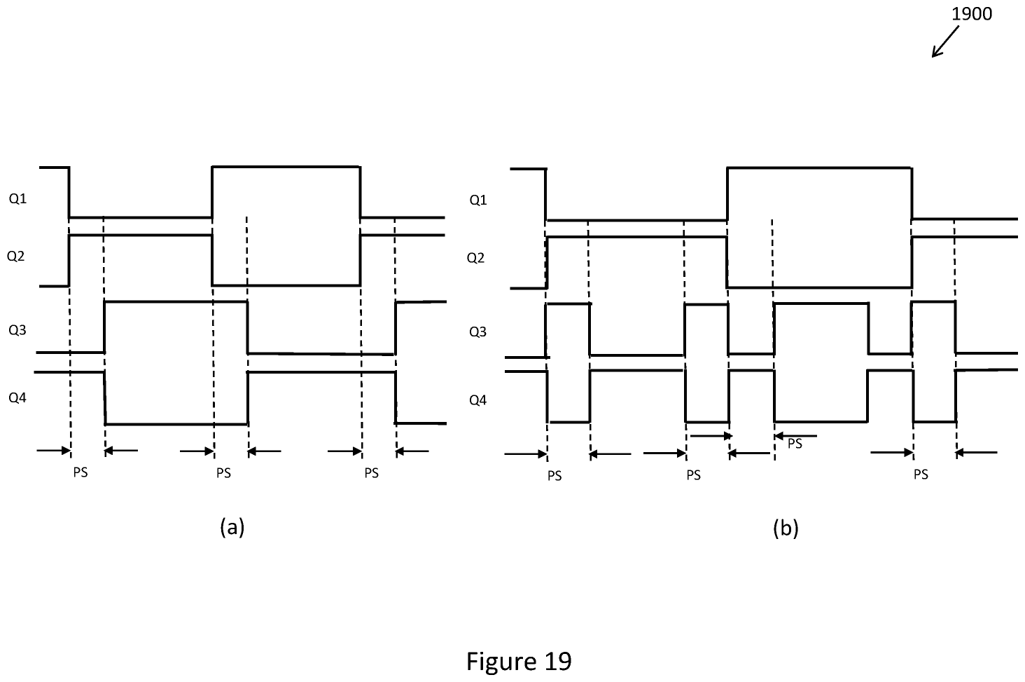

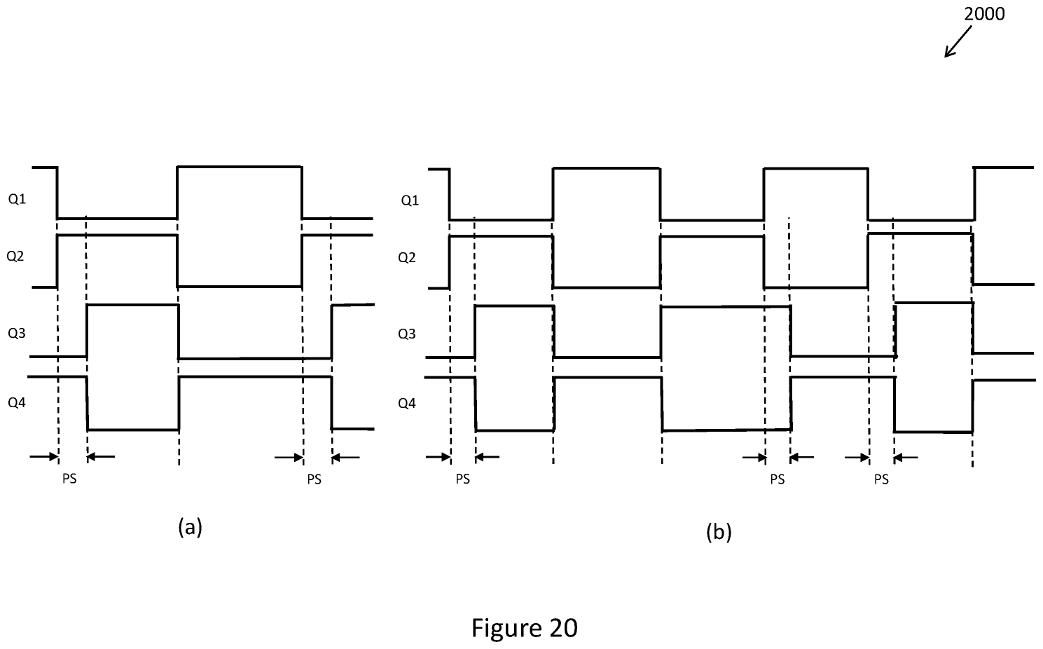

In a rectifier connected to a resonant tank, the current in a rectifier switch usually is the same as a current in the resonant tank during certain period. If the rectifier is in full rectification mode to emulate diode rectification, the rectifier switch would be turned when the current flowing into it is positive, and as a result deliver the positive current to the dc rail. For example, in FIG. 1, in a normal full-rectification operation in which Q_{DT1} and Q_{DT2} are off, the current in Q1 (labeled as I(Q1)) is the positive portions of current in C_{RX1} (labeled as I(C_{RX1})), and L_{RX} (labeled as I(L_{RX})), which is also the negative portion of current in C_{DT2} (I(C_{DT2})). By sensing a current in the resonant tank, such as I(C_{RX1}) or I(L_{RX}), the current in a power switch such as Q1 can be determined, and the gate drive signals of power switches such as Q1 can be determined by the polarity (or direction) of such current, which in turn can be determined by detecting zero crossing of the currents. Of course, it is also feasible to sense current in one or more power switches to determine the gate signals of the power switches, which is equivalent to, but in implementation usually more difficult than, sensing a current in the resonant tank. In principle, the phase shift control in a rectifier is to shift the gate drive signals of some power switches in it away from the current's zero crossing, i.e. intentionally make the power switch conducts positive current for less duration to reduce the power delivered to the output compared to full rectification. Phase-shift control can be implemented in both half-bridge and full-bridge rectifiers, but we will use the full-bridge rectifier shown in FIG. 1 as an example. FIGS. 19 and 20 show examples of phase-shift strategies. In a full bridge phase-shift control, two rectifiers can conduct currents as in full rectification, i.e. are non-shifted and can be implemented as diodes or controlled as synchronous rectifier. For example, in FIG. 1, Q1 and Q2, or Q1 and Q3, or Q3 and Q4, or Q2 and Q4 are several choices for a non-shift pair/leg (in half-bridge, either top or bottom switch can be a non-shift switch). The power switches a non-shift pair should be drive according to the direction of the current flowing into the ac load of the leg, which is the same as the current in L_{RX}. In practice, the gate drive signals for the non-shifting pair can be derived from zero-crossing signals detected on the current in L_{RX} or in a switch. As there is a resonant tank in the RX, and the coil current in the RX resonant tank may be very sensitive to the reflected voltage of the rectifier (i.e. the ac voltage between the two ac nodes of the full bridge), we need to look at both the reflected voltage and delivered current to the output during phase-shift control to develp a proper power control.

We will use Q1 and Q2 as the non-shift switches as an example in below discussion. That is, Q1 and Q2 are gated according to the direction of current in C_{RX1} (please note that the current of C_{RX1} is the same as current of L_{RX} but opposite that of C_{RX2} during this mode of operation) to emulate diode rectification during the phase shift control (or left uncontrolled with gate signals off if desired). FIG. 19 shows examples of gate drive timing diagram for the power switches in FIG. 1. FIG. 19(a) shows the first phase-shift control strategy. The gate drive signals of Q1 and Q2 are derived from the direction of current in the resonant tank (L_{RX}, C_{RX1} or C_{RX2}), and the current direction signal may be obtained by detecting zero crossing of the current. The gate drives of Q3 and Q4 are complementary, and both phase shifted against the current direction of C_{RX1}, and thus the gate signals of Q1 and Q2. In the figure, the gate drive waveform of Q3 and Q4 is symmetrical to that of Q1 and Q2, and PS is the amount of the phase shift between them. The current delivered to the output is quite sensitive to the phase shift (PS). For example, if the phase shift is 90°, the delivered current is practically zero. FIG. 19(b) shows the second phase-shift strategy, where on each half-cycle, Q3 and Q4 conduct current symmetrically against the center point of the half cycle, but at the expenses of doubled switching frequency (i.e. higher switching power loss). The current delivered to the load is not as sensitive to the phase shift as in the first strategy, and the reduced sensitivity may help achieve a smoother transient response. In these two strategies, Q3 and Q4 in the rectifier operates symmetrically. It is also possible to use asymmetric phase-shift control strategies. FIG. 20(a) shows a strategy that Q3's conduction time reduces with the increase of PS, and Q4, controlled to be complementary to Q3, sees its conduction time increasing with the increase of PS, in contrast to the counterparts in FIG. 19(a). Unlike in FIG. 19(a), the current delivered to VRECT now is always positive and no longer has a negative portion during a half cycle, so the power performance is improved from the first control strategy. But now the current in the RX coil is no longer symmetric, and may have even orders of harmonic contents, which is sometimes undesired. To avoid this, the second symmetric control strategy shown in FIG. 20(b) may be used, in which Q3 and Q4 are phase-shifted alternatively. This makes the gate signals of Q3 and Q4 symmetrical, but effectively reduces the harmonic frequency, i.e. the current may have subharmonic contents. If the harmonic contents happen only during transients, they may be tolerable in most applications.

In this disclosure, FIGS. 19(a) and 19(b) are collectively referred to as FIG. 19, and FIGS. 20(a) and 20(b) are collectively referred to as FIG. 20. FIGS. 19 and 20 illustrate some examples of phase-shift control strategies, and more control strategies can be devised using similar concepts. In a TX or RX for a WPT system, there is usually a resonant tank (sometimes also called a resonator) to shape the resonant current flowing through a switch network coupled to a rail which has a dc voltage, and the switch network also presents a reflected voltage, determined by the status of power switches in the switch network with its amplitude determined by the dc voltage, to the resonant tank. The essence of the phase-shift control is to regulate the system output by adjusting the phase shift between the resonant current and the reflected voltage through proper arrangement of the gate drive signals for the power switches. The resonant tank and the switch network may use different topologies. For example, the resonant tank may use a series resonant, parallel resonant, series-parallel resonant or other topologies, and the switched network may use a full-bridge, half-bridge, push-pull, class-e or other topologies. The timing of power switches may be altered to suite the topology used. For example, in half-bridge switch network, the top switch may be configured to be turned on with a controllable phase shift against the resonant current's positive zero-crossing, and turned off at the negative zero-crossing, and the bottom switch may be configured to be switched in complementary to the top switch. In a receiver, the switch network may be configured to operate as a rectifier, and the phase-shift control may be integrated with synchronous rectifier control to provide synchronous rectification while regulating the voltage, current, or power at the output. In a transmitter, the phase-shift control may be used to adjust turn-on or turn-off time of power switches against a zero crossing of their currents, and thus create a preferred soft-switching condition for the power switches in the switch network through adjusting the turn-on or turn-off current, as such current may in turn be configured to reduce the switches' voltage at turn-on instants. The topology switching described previously may also be implemented with a special phase-shift control, so the switch duty cycle may have a smooth transition resulting from a smooth change of the phase shift between two groups of switches. Please note that a phase-shift control strategy may be implemented in combination with other control means, such as resonance modulation, burst mode control (skip mode control), and detuning control, and may be realized with software, hardware and a combination thereof.

The above discussion is based on wireless charging devices and systems. It should be known that the techniques presented in this disclosure can also be applied to other applications, such as power supplies and power management ICs.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A device comprising:
a switch network having a plurality of power switches and coupled between a dc rail with a dc voltage, and a resonant tank having a first coil and a resonant capacitor, wherein gate drive signals of a group of power switches of the plurality of power switches in the switch network are configured to be turned on with a phase shift against a zero crossing of a current in the resonant tank, and wherein the phase shift is configured to adjust the dc voltage or establish a soft-switching condition for the plurality of power switches in an operation mode.

2. The device of claim 1, wherein:
the resonant capacitor is a variable capacitor with a controllable capacitance.

3. The device of claim 2, wherein:
the variable capacitor is configured to regulate the dc voltage of the dc rail.

4. The device of claim 1, wherein:
the device is a receiver of a wireless power transfer system, and the dc rail is coupled to a battery through a switched capacitor converter.

5. The device of claim 1, wherein:
the first coil is configured to be magnetically coupled to a second coil, and wherein a current flowing through the second coil is controlled in coordination with a phase shift adjustment in the operation mode.

6. The device of claim 1, further comprising:
a plurality of detuning branches, each with a detuning capacitor and a detuning switch, wherein a capacitance of the detuning capacitor is much higher than a capacitance of the resonant capacitor.

7. The device of claim 6, wherein:
the detuning switch is configured to control the dc voltage.

8. The device of claim 1, wherein:
the dc rail is coupled to an input port through an Oring device.

9. The device of claim 1, wherein:
the switch network comprises a full bridge, and power switches in a leg of the full bridge are configured to be switched in synchronization with the zero crossing.

10. The device of claim 9, wherein:
the phase shift is configured such that duty cycles of the switches in the leg of the full bridge gradually change so as to configure the full bridge to transition from a full-bridge mode to a half-bridge mode.

11. The device of claim 9, wherein:
the leg of the full bridge comprises a plurality of switchable half-bridge cells, and wherein each switchable half-bridge cell comprises a regular half-bridge cell connected to a load switch and a cell resonant capacitor, and the load switch is configured to switch in or out the regular half-bridge cell such that the equivalent resonant capacitance of the resonant tank is adjusted.

12. A system comprising:
a first device comprising a first switch network having a plurality of first power switches and coupled between a first dc rail with a first dc voltage, and a first resonant tank having a first coil and a first resonant capacitor, wherein gate drive signals of a group of first power switches in the plurality of first power switches in the first switch network are configured to be turned on with a phase shift against a zero crossing of a current in the first resonant tank, and wherein the phase shift is configured to adjust the first dc voltage or to establish a soft-switching condition for the plurality of first power switches in an operation mode; and
a second device comprising a second switch network having a plurality of second power switches and coupled between a second dc rail with a second dc voltage, and a second resonant tank having a second coil and a second resonant capacitor, wherein the second coil is magnetically coupled to the first coil.

13. The system of claim 12, further comprising:
a communication channel between the first device and the second device configured to adjust the second dc voltage in response to a change of the first dc voltage.

14. The system of claim 12, wherein:
the first switch network comprises a full bridge, and power switches in a leg of the full bridge are configured to be switched in synchronization with the zero crossing.

15. The system of claim 13, wherein:
the phase shift is configured to gradually change duty cycles of the power switches in the leg of the full bridge to switch the full bridge between a full-bridge mode and a half-bridge mode.

16. The system of claim 15, wherein:
the full bridge is configured to operate in a half-bridge mode in response to a weak magnetic coupling between the first coil and the second coil.

17. A method comprising:
configuring a switch network having a plurality of power switches and coupled between a dc rail with a dc voltage, and a resonant tank with a coil and a resonant capacitor;
detecting a zero crossing of a current flowing in the resonant tank;
in response to the zero crossing, configuring gate drive signals of a group of power switches of the plurality of power switches to be turned on with a controllable phase shift against the zero crossing; and
adjusting the phase shift to adjust the dc voltage or to establish a soft-switching condition for the plurality of power switches in an operation mode.

18. The method of claim 17, further comprising:
configuring the switch network to operate in a half-bridge configuration in a first operation mode and operate in a full-bridge configuration in a second operation mode.

19. The method of claim 18, further comprising:
adjusting the phase shift to gradually change a duty cycle of one of the plurality of power switches in the switch network in a transition between the first operation mode and the second operation mode.

20. The method of claim 19, further comprising:
reducing a reference in the transition to reduce a voltage stress or a current stress.
